(19) United States
(12) Patent Application Publication
(10) Pub. No.: US 2018/0008849 A1
(43) Pub. Date: Jan. 11, 2018

(54) FIT-CHECKING APPARATUS

(71) Applicant: Design Reality Ltd., St. Asaph (GB)

(72) Inventor: Troy Baker, St. Asaph (GB)

(21) Appl. No.: 15/641,199

(22) Filed: Jul. 3, 2017

(30) Foreign Application Priority Data
Jul. 8, 2016 (GB) 1611931.5

(51) Int. Cl. A62B 27/00; A62B 18/02; G01M 3/32; A62B 9/00

(52) U.S. Cl. CPC A62B 27/00; G01M 3/3218; A62B 18/02; A62B 9/006

(57) ABSTRACT

A respirator fit-check apparatus has an air pressure sensor adapted, in use, to sense the air pressure within a sealed interior volume of a close-fitting respirator; an indicator adapted, in use, to indicate instructions and test results to a wearer of the respirator; and a CPU, the apparatus being configured to monitor the air pressure within the respirator and to determine and indicate whether or not the respirator seals to the face of a wearer based on a vacuum decay over a specified period of time. The apparatus may also be configured to monitor the breathing depth and/or rate of the wearer subsequent to a fit-check determination.

### CROSS-REFERENCE TO RELATED APPLICATION

This application claims priority from, and the benefit of, United Kingdom patent application No. GB1611931.5, filed 8 Jul. 2016, the entire disclosure of which is hereby incorporated herein by reference.

### TECHNICAL FIELD

This invention relates to a fit-checking apparatus and method suitable, in particular, but without limitation, for fit-checking of close-fitting respirator equipment.

### BACKGROUND ART

Respirators, or self-contained breathing apparatus (SCBA), are used by people working in hazardous environments to reduce, or eliminate, the possibility of inhaling harmful contaminants. For example, soldiers and firefighters often wear SCBA systems to protect them from smoke or other airborne contamination; and respirators are routinely worn in factory environments to protect workers from dust, paint spray and volatile chemicals.

Respirators and SCBA differ from “dust masks” (which are loose-fitting facial PPE items) and also from “positive pressure” PPE equipment (which inhibit contaminants from being inhaled by providing a constant airflow away from the user's face to push-away airborne contaminants) insofar as they rely upon forming an airtight seal around a user's nose and mouth (in the case of “half-mask” equipment) and/or around a user's face (in the case of “full-face” equipment).

Respirators and SCBA therefore rely upon the formation of an effective, airtight seal between the respirator and the user's face and the integrity of the seal between the respirator and the user's face is thus of paramount importance.

In order to ensure that this is the case, a respirator user must be provided with an appropriately-sized and -shaped respirator (different people having different head shapes and sizes); and the respirator must be periodically checked to ensure that it seals correctly. A range of variables can adversely affect the fit, and hence the sealing properties, of a respirator, such as, for example: the growth of a beard or stubble; degradation of, or damage to, the main body of the respirator; degradation of, or damage to, the seals between the respirator and its air supply or filter cartridge; degradation of, or damage to, the face seal(s) itself; and so on. As such, users of respirators need to be periodically “fit-checked” to ensure that their respirator is, and remains, effective.

Quantitate fit-checking is generally carried out using specialist laboratory equipment comprising a sealed test chamber in which a respirator-wearing subject sits or stands; an evaporator adapted to “contaminate” the air within the test chamber with an inert, but nevertheless detectable, contaminant (usually a salt vapor) to a certain specified minimum concentration; and a detector. The detector is configured, using a pump and an umbilical tube connected to the subject's respirator, to detect the concentration of the contaminant inside the subject's respirator during a test interval. The subject is usually required to carry out certain physical movements, such as head shaking etc. during the test, to simulate actual use conditions. If the subject's respirator is functioning correctly, and if it fits correctly (forms an airtight seal to the subject's face), then the detector will not be able detect significant levels of contaminants within the subject's respirator above a certain “pass” threshold. However, if the subject's respirator is defective, or if its seal is breached during the test, then the detector will detect an unacceptably high level of contamination within the respirator, thereby signaling a “fail” result.

Whilst quantitative fit-checking equipment, such as that described above, can provide a definitive, quantitative pass/fail result, it tends to be very expensive to purchase, often requires specially-trained operatives to work it, and the test is time-consuming and can be unpleasant for the subject. As a result, quantitative fit checks are usually carried out periodically, say every six months, which may not be adequate where a respirator could fail immediately after a fit check, and that failure not be detected for some time.

Therefore, between quantitative fit checks, respirator users are usually required to carry out qualitative fit checks every time they use the respirator. A qualitative fit check often just involves closing-off the respirator's air inlet (filter cartridge socket or airline) and the user inhaling and then holding his/her breath to “suck” the respirator tightly onto his/her face. If the subject's respirator is functioning correctly and if it fits correctly, then the resultant vacuum within the respirator will be maintained until such time as the user exhales into it, or until the air inlet is re-opened. If, however, the subject's respirator is faulty or if it fits badly, then the user can “feel” the loss of vacuum, or hear a “hiss”, signaling that the respirator is faulty and/or requires re-fitting. However, qualitative fit checks are generally accepted to be inadequate for detecting 1) minute perforations in the respirator/its seals; 2) loss of respirator effectiveness caused by beard growth, scars or other small facial changes; or 3) gradual changes in “fit” over time. Also, as each user may have a different lung capacity and tolerance to/ability for breath-holding, is it not possible to know whether one user's “pass” assessment is the same as user's.

### SUMMARY

It will be readily apparent from the foregoing that there is a need for an intermediate type of fit check apparatus and/or method, i.e. one lying somewhere between the known quantitative and qualitative fit checks described above, which is more accurate and reliable than the “suck-in” qualitative fit checks currently prescribed; but less expensive and more convenient than known, periodic, quantitative fit checks.

This invention aims to provide a solution to one or more of the above problems, and/or to provide an alternative to known qualitative and/or quantitative respirator fit check systems and methods. Various aspects of the invention are set forth in the appended claims.

According to a first aspect of the invention, there is provided a respirator fit-check apparatus comprising: an air pressure sensor adapted, in use, to sense the air pressure within a sealed interior volume of a close-fitting respirator; an indicator adapted, in use, to indicate instructions and test results to a wearer of the respirator; and a CPU operatively connected to the air pressure sensor and to the indicator, wherein the CPU is adapted, in use, to: indicate, via the indicator, the start of a fit-check procedure and to monitor a drop in air pressure within the sealed interior volume of the respirator until a lower threshold air pressure value is reached; indicate, via the indicator, that the lower threshold air pressure value has been reached and to monitor the air pressure within the sealed interior volume of the respirator for a predetermined period of time; indicate, via the indicator, the expiry of the predetermined period of time; determine whether the measured air pressure within the sealed interior volume of the respirator at the end of the said predetermined period of time is below or above an upper threshold value; and if the measured air pressure within the sealed interior volume of the respirator at the end of the said predetermined period of time is below the upper threshold value, to indicate, via the indicator, a “pass” result; or if the measured air pressure within the sealed interior volume of the respirator at the end of the said predetermined period of time is above the upper threshold value, to indicate, via the indicator, a “fail” result.

A second aspect of the invention provides a respirator fit-check apparatus comprising: an air pressure sensor adapted, in use, to sense the air pressure within a sealed interior volume of a close-fitting respirator; an indicator adapted, in use, to indicate instructions and test results to a wearer of the respirator; and a CPU operatively connected to the air pressure sensor and to the indicator, wherein the CPU is adapted, in use, to: indicate, via the indicator, the start of a fit-check procedure and to monitor an increase in air pressure within the sealed interior volume of the respirator until an upper threshold air pressure value is reached; indicate, via the indicator, that the upper threshold air pressure value has been reached and to monitor the air pressure within the sealed interior volume of the respirator for a predetermined period of time; indicate, via the indicator, the expiry of the predetermined period of time; determine whether the measured air pressure within the sealed interior volume of the respirator at the end of the said predetermined period of time is below or above a lower threshold value; and if the measured air pressure within the sealed interior volume of the respirator at the end of the said predetermined period of time is above the lower threshold value, to indicate, via the indicator, a “pass” result; or if the measured air pressure within the sealed interior volume of the respirator at the end of the said predetermined period of time is below the lower threshold value, to indicate, via the indicator, a “fail” result.

A third aspect of the invention provides a method of determining the fit of a close-fitting respirator, the method comprising: indicating, via an indicator, the start of a fit-check procedure; sealing the inlet of the respirator; a wearer of the respirator inhaling to reduce the pressure within a sealed interior volume of the respirator; monitoring, using an air pressure sensor located within the sealed interior volume of the respirator the reduction in air pressure within sealed interior volume of the respirator; upon the air pressure within sealed interior volume of the respirator reaching a lower threshold value, indicating to the wearer, using an indicator, to hold his/her breath; monitoring the air pressure within the sealed interior volume of the respirator for a predetermined period of time; indicating, via the indicator, the expiry of the predetermined period of time; and determining using a CPU operatively connected to the air pressure sensor and indicator, whether the measured air pressure within the sealed interior volume of the respirator at the end of the said predetermined period of time is below or above an upper threshold value; and if the measured air pressure within the sealed interior volume of the respirator at the end of the said predetermined period of time is below the upper threshold value, indicating, via the indicator, a “pass” result; or if the measured air pressure within the sealed interior volume of the respirator at the end of the said predetermined period of time is above the upper threshold value, indicating, via the indicator, a “fail” result.

A fourth aspect of the invention provides a method of determining the fit of a close-fitting respirator, the method comprising: indicating, via an indicator, the start of a fit-check procedure; sealing the inlet of the respirator; a wearer of the respirator exhaling to increase the pressure within a sealed interior volume of the respirator; monitoring, using an air pressure sensor located within the sealed interior volume of the respirator the increase in air pressure within sealed interior volume of the respirator; upon the air pressure within sealed interior volume of the respirator reaching an upper threshold value, indicating to the wearer, using an indicator, to hold his/her breath; monitoring the air pressure within the sealed interior volume of the respirator for a predetermined period of time; indicating, via the indicator, the expiry of the predetermined period of time; and determining using a CPU operatively connected to the air pressure sensor and indicator, whether the measured air pressure within the sealed interior volume of the respirator at the end of the said predetermined period of time is below or above a lower threshold value; and if the measured air pressure within the sealed interior volume of the respirator at the end of the said predetermined period of time is above the lower threshold value, indicating, via the indicator, a “pass” result; or if the measured air pressure within the sealed interior volume of the respirator at the end of the said predetermined period of time is below the lower threshold value, indicating, via the indicator, a “fail” result.

The air pressure sensor suitably comprises an electronic pressure sensor or transducer. The air pressure sensor is adapted, in use, to sense the air pressure within a sealed interior volume of a close-fitting respirator. By close-fitting respirator, it is meant a respirator that seals, in use, to a wearer's face. The air pressure sensor can be located anywhere within the sealed interior volume of the close-fitting respirator, for example, within an oral nasal unit of the respirator; between the visor and the wearer's face of a full-face respirator; within the filter cartridge or airline of the respirator; or in an adaptor sealingly interposed between the respirator and one of its filter cartridges and/or airline. These are merely examples, and do not constitute an exhaustive list.

The indicator adapted is, in use, to indicate instructions and test results to a wearer of the respirator. The indicator may comprise an audible and/or visible indicator. For example, the indicator may comprise a beeper or speaker. In such a situation, the indicator may emit a beep sound to indicate the start of a test procedure. Whilst the wearer is inhaling to reduce the pressure within the respirator, the indicator may emit a series of short beeps, followed by a long, and/or louder beep to indicate that the pressure within the respirator has fallen to, or below, the lower threshold value. A continuous beep may then be emitted to signal to the wearer to hold his/her breath, followed by a further beep at the end of the test procedure. The test result can be indicated by a “pass” beep sequence, such as a short, low-pitched beep followed by a short higher-pitched beep; or a “fail” beep sequence, such as a short, high-pitched beep followed by a short lower-pitched beep. The foregoing explains how the indicator can be used in a “negative pressure test” situation, but it could also be used in a “positive pressure fit-check” procedure, in which case the indicator may omit a beep sound to indicate the start of a test procedure. Then, whilst the wearer is exhaling to increase the pressure within the respirator, the indicator may omit a series of short beeps, followed by a long, and/or louder beep to indicate that the pressure within the respirator has increased to, or exceeded, the upper threshold value. A continuous beep may then be omitted to signal to the wearer to hold his/her breath, followed by a further beep at the end of the test procedure. Again, the test result can be indicated by a “pass” beep sequence, such as a short, low-pitched beep followed by a short higher-pitched beep; or a “fail” beep sequence, such as a short, high-pitched beep followed by a short lower-pitched beep.

The foregoing is just an illustrative example, and the scope of the invention is not limited by it.

Additionally or alternatively, the indicator may comprise one or more LEDs located within the wearer's line of sight. Suitably, an LED indicator may be located on top of the oral nasal unit or nose cup of the respirator, or it may be affixed to the inside of the respirator's visor. Other locations are also possible, such as associated with the filter cartridge. Where one or more indicator LEDs are provided, there may be a plurality of differently-coloured LEDs, or a single colour-changing LED.

In such a situation, the indicator may emit red light to indicate the start of a test procedure. Whilst the wearer is inhaling to reduce the pressure within the respirator, the indicator LED may flash red, followed by amber to indicate that the pressure within the respirator has fallen to, or below, the lower threshold value. The LED may then flash amber to signal to the wearer to hold his/her breath, followed by continuous amber at the end of the test procedure. The test result can be indicated by a green light to indicate a “pass” result, or red light to indicate a “fail” result.

As before, the opposite may be true for a “positive pressure test” fit-check procedure, in which case the indicator may omit a red light to indicate the start of a test procedure. Then whilst the wearer is exhaling to increase the pressure within the respirator, the indicator LED may flash red, followed by amber to indicate that the pressure within the respirator has fallen to, or exceeded, the upper threshold value. The LED may then flash amber to signal to the wearer to hold his/her breath, followed by continuous amber at the end of the test procedure. The test result can be indicated by a green light to indicate a “pass” result, or a red light to indicate a “fail” result.

Again, the foregoing is just an illustrative example, and the scope of the invention is not limited by it.

In certain embodiments of the invention, the indicator is a separate unit from the pressure sensor/CPU, for example, an app that is displayed on a computer, tablet PC or a smartphone device. This can be accomplished by providing a wireless RF communication link, such as a Wi-Fi (IEEE 802.11XX standard), Bluetooth^{RTM} (IEEE 802.15.1X standard), or Zigbee^{RTM} (IEEE 802.15.4X standard) between the CPU and the computer, tablet PC or a smartphone device. In this case, the instructions to the wearer and/or the test results can be presented via a GUI of the computer, tablet PC or a smartphone device.

In order to preserve battery life, the CPU may have sleep (substantially or completely powered-down) and active (powered-up) modes. The CPU may “wake” from sleep mode in response to a signal from the air pressure sensor, such as a sudden pressure drop. Thus, a user may be able to instigate a test by putting his/her respirator on, closing its inlet, and by inhaling suddenly to suck the respirator onto his/her face, which when wakes-up the CPU so that a fit-test procedure can commence. Where the indicator is provided on a computer, tablet PC or a smartphone device, the user can wake-up the CPU by initiating a connection session between the computer, tablet PC or a smartphone device and the CPU, or by pressing a button, soft key or GUI region to force the CPU to switch to the wake mode.

The CPU may automatically revert to the sleep mode, to preserve battery life, after a predetermined interval, although this is not essential.

The CPU suitably comprises a dedicated system-on-chip (SOC) device, which comprises a processor, an I/O interface for the pressure sensor, indicator and an optional wireless transceiver. The CPU may also comprise a memory for storing, for example, historical test results, test data and their corresponding dates/times. The I/O interface of the CPU may be interrogated by an external computer, tablet PC or a smartphone device for monitoring and/or record keeping purposes.

One possible further use of the invention subsists in monitoring the breathing of respirator wearers. The CPU can be configured to measure the pressure within the respirator to monitor the breathing rate and depth of the wearer at intervals, or continuously.

For example, if the breathing rate of the wearer increases (e.g. detected by a decrease in the periodicity of the sensed air pressure rise-fall pattern), then this may signal exertion or stress. Additionally or alternatively, if the breathing depth of the wearer increases (e.g. detected by a lower average sensed air pressure within the respirator), then this may signal clogging or obstruction of the filter cartridge or airline.

Additionally or alternatively, if the wearer removes his/her respirator, or if the respirator fails (e.g. detected by an average increased, or continuous neutral sensed air pressure within the respirator), then this may give rise to a warning situation.

The CPU may be configured to emit audible, visible and/or RF warning signals to alert the wearer/others of such situations.

The CPU is adapted to monitor an increase in air pressure within the respirator during the interval of the fit-check test, i.e. between the “hold breath” and “test complete” times. Conversely, the CPU is adapted to monitor a decrease in air pressure within the respirator during the interval of the fit-check test, where the invention is used in a “positive pressure test” configuration. —Suitably, the CPU takes a series of air pressure measurements, say every 100 ms, and records the readings in a memory of the CPU. A plot of pressure versus time can then be made, and the gradient and/or shape of that plot can signify different states of the respirator. Ultimately, the respirator is deemed to “pass” if there is a good seal and air cannot enter (or leave) the respirator during the fit-check test. If there is a perfect seal, then the air pressure at the end of the fit-check test will be the same as it was at the beginning of the fit-check test. However, this will rarely, if ever, be the case, in practice. In most cases, there will be some leakage and the pressure within the sealed interior volume of the respirator, at the end of the fit-check procedure, will be higher than it was at the beginning, for a “negative pressure test” procedure, or lower than it was at the beginning, for a “positive pressure test” procedure. A certain amount of leakage is acceptable, and this is determined by the upper (or lower) threshold value as the case may be. By ensuring, however, that the pressure within the respirator at the start of the fit-check procedure is always at, or below the lower threshold value (or at or above the upper threshold value in the case of a “positive pressure test”), it is possible to standardize the fit-check test and therefore be able to make reasonable comparisons between different test results for the same user at different times, or between different users. The standardization of the fit-check procedure enables fit-check test results to be monitored centrally, for example, via a cloud service provider, to indicate more reliably when quantitative fit-check test is needed. This enables the planning and provisioning of quantitative fit-checks to be better optimized, and can be used to identify sudden respirator failures, or user error (requiring re-training), between quantitative fit-check tests, which is not hitherto possible.

Further, because the CPU can be configured to analyze the shape of the aforesaid pressure-time plot, this can be used to indicate incorrect user operation. For example, if a user wearing a good, well-fitting respirator does not hold his/her breath for long enough, then the air pressure at the end of the fit-check may indicate a “fail” result. However, if it can be discerned from the pressure-time plot that up to the point of releasing his/her breath, the gradient of the pressure-time plot would have resulted in a “pass” (if only the wearer had held his/her breath for long enough, then the CPU may be configured to signal a re-test required result, or a conditional pass result. If a particular user repeatedly gets “re-test required” or “conditional pass” results, then this may indicate the need for further training.

### BRIEF DESCRIPTION OF THE DRAWINGS

Embodiments of the invention shall now be described, by way of example only, with reference to the accompanying drawings, in which:

FIG. 1 is a schematic system diagram of a fit-checking apparatus in accordance with the invention;

FIG. 2 is a perspective view of a half-mask respirator incorporating a fit-check system in accordance with the invention;

FIG. 3 is a perspective view of a half-mask respirator fitted with an adaptor incorporating a fit-check system in accordance with the invention;

FIG. 4 is a perspective view of a full-face respirator incorporating a fit-check system in accordance with the invention;

FIG. 5 is a perspective view of a full-face respirator fitted with an adaptor incorporating a fit-check system in accordance with the invention;

FIG. 6 is schematic a view from inside the full-face respirator of FIGS. 4 and 5;

FIG. 7 is a graph showing the fit-check test results obtained for an intact, and a damaged respirator using a known quantitative fit check apparatus;

FIG. 8 is a graph showing the fit-check test results obtained for the same intact and damaged respirators using a fit-checking apparatus in accordance with the invention; and

FIG. 9 is a graph comparing the fit-check test results for the intact respirator: comparing the test results for the same user when clean-shaven, and with facial hair.

### DETAILED DESCRIPTION

### Example 1

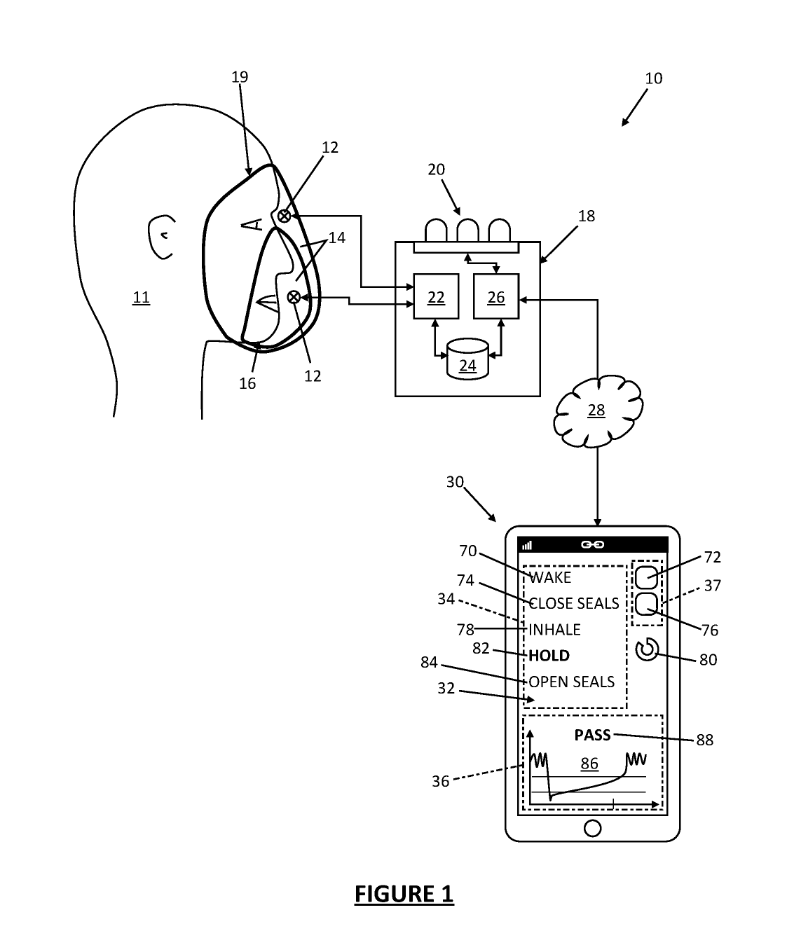

Referring to FIG. 1 of the drawings, a fit-checking apparatus 10 in accordance with the invention comprises an air pressure sensor 12 located with the sealed interior 14 of a half-mask 16, or a full-face 18 respirator, a central processing unit (CPU) 18 and an indicator 20.

The air pressure sensor 12 is an electronic pressure transducer which is located somewhere within the sealed interior volume 14 of the respirator 16, 18, that is to say within the oral-nasal unit of a half-mask respirator 18, or inside the visor of a full-face respirator 18 (as shown in FIG. 1, although other air pressure sensor locations are possible, as shall be explained later). For the purposes of understanding the invention, the sealed interior volume 14 of the respirator 16, 18 includes the entire volume bounded by the line of contact between the respirator and the wearer's face, the interior surfaces of the respirator 16, 18. The sealed interior volume 14 can also include the interior of the respirator's filter cartridges and/or airline.

The air pressure sensor 12 is connected to a processor 22 of the CPU 18, which is adapted to poll the air pressure sensor 12 at intervals (say every 200 ms during a fit-check procedure) for air pressure readings (as sensed by the air pressure transducer(s) 12) within the sealed interior volume 14 of the respirator 16, 18. A memory device 24, such as a RAM chip, is operatively connected to the processor 22 and is configured to store the sensor readings. An input-output (I/O) device 26 is also incorporated within the CPU 18, and this provides an interface between the processor 22 and the indicator 20.

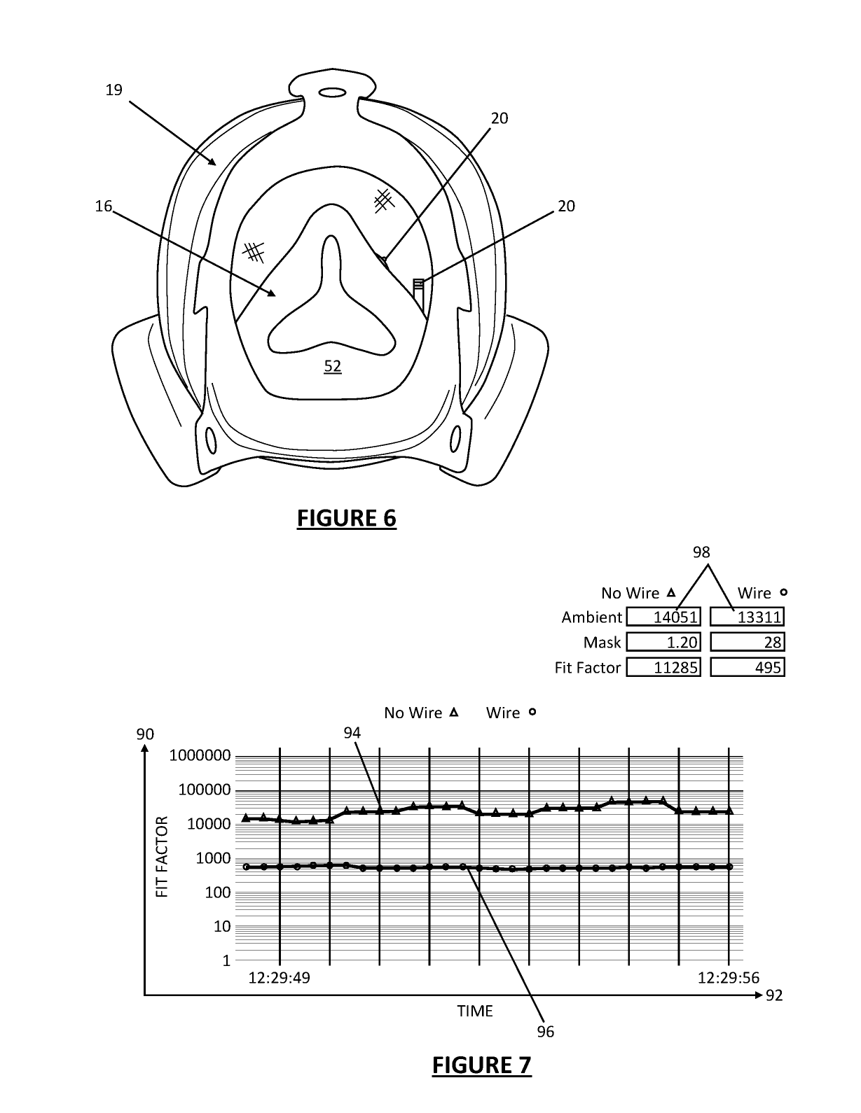

In the embodiment shown in FIG. 1, the indicator 20 comprises a set of three LEDs, which are located so as to be visible by a wearer of a respirator 16, 18, as is shown in FIG. 6, during a fit-checking procedure. Also shown in FIG. 1 of the drawings is a wireless network 28, to which the I/O device 26 can connect, for example via Bluetooth^{RTM} or Wi-Fi, to a computer, tablet or smartphone device 30. The smartphone device 30 has a graphical user interface (GUI) 32, which displays instructions 34 and test results 36 to a user.

### Example 2

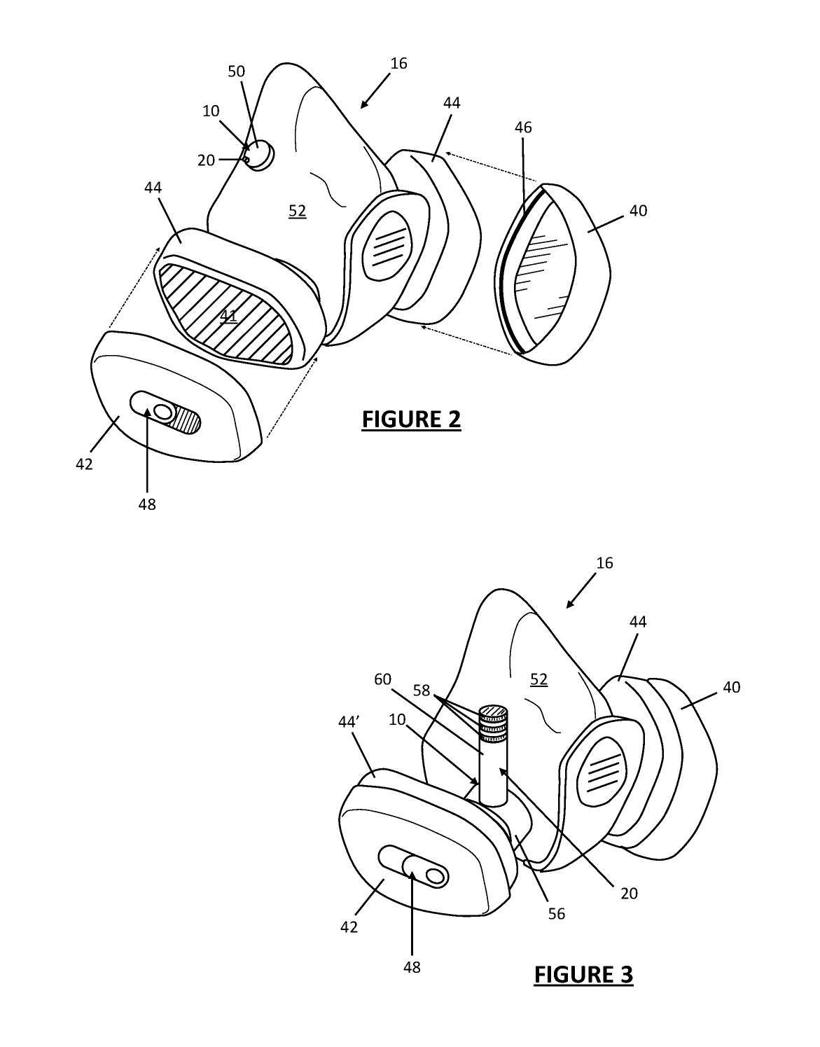

Referring now to FIGS. 2 to 5 in conjunction with FIG. 1, in use, a user 11 puts on the respirator 16, 18 and seals off the respirator's air inlets. This can be accomplished by sealingly covering over the air inlet apertures 41 of the respirator's filter cartridges 44 (for example, by pressing rubber-gloved hands over the filter cartridge's inlet apertures) or by closing-off the respirator's airline (not shown), for example, using a valve (not shown). Preferably, however, in the case of a filter cartridge respirator 16, 18, a set of sealing caps 40, 42 are provided for this purpose. A first one of the sealing caps 40 has an inner profile which is shaped to correspond to the exterior profile of the filter cartridge 44. An O-ring seal 46 is also provided such that when the cap 40 is pressed onto the filter cartridge 44, it forms an airtight seal therewith, effectively closing it off. A second one of the sealing caps 42 is similarly-constructed, having an inner profile corresponding to the exterior profile of the other filter cartridge 44, and an O-ring seal 46 which forms an airtight seal when the cap 42 is pressed onto the other filter cartridge 44. However, the second sealing cap 42 also has a slide valve 48, which can be opened to allow the wearer to breathe through the filter cartridge 44, or closed to form the requisite airtight seal. Thus, the sealed interior volume 14 for fit-check testing is formed.

The user forms the sealed interior volume 14 (by whatever means), and wakes-up the fit checking apparatus 10 by sharply inhaling. The inhalation causes the air pressure within the sealed interior volume 14 to drop suddenly, and this is detected by the CPU 18, which enters an “active” state.

The CPU begins the fit-check procedure by indicating to the wearer (for example, by illuminating an LED) to inhale until a predetermined lower threshold air pressure within the sealed interior volume 14 has been reached, and then to hold his/her breath for a predetermined period of time, say 10 seconds. The CPU 18 polls the air pressure sensor 12 at 200 ms intervals for the duration of the test, and records the air pressure readings in its memory device 24. At the end of the fit-check procedure, the indicator 20 signals to the user to open the air inlets 41, 48 and to breathe normally again.

The processor 22 then plots the air pressure sensor readings as a function of time, and determines whether or not the air pressure within the sealed interior volume 14 of the respirator 16, 18 is below or above the upper threshold value. If it is below, it indicates a “pass” result, otherwise, it indicates a “fail” result.

The user instructions and test results can be indicated visually, for example, by using different LED colour and flashing sequences (as mentioned above), or by using different sound sequences, where the indicator comprises a beeper or speaker device (not shown).

### Example 3

In the embodiment shown in FIG. 2 of the drawings, the fit-checking apparatus 10 is formed in a small, disc-shaped plastics housing 50, which is sealingly adhered to the exterior of the oral nasal unit 52 of a half-face mask respirator 16. The fit-checking apparatus 10 has a pressure sensor (not visible) located on its underside, which registers with a small through hole (not visible) in the oral nasal unit 52. Thus, the pressure sensor is in fluid communication with the interior volume of the respirator 16.

The indicator 20 comprises a colour-changing LED, which protrudes above the housing 50 of the fit-checking apparatus 10. The LED 20 is just visible to a user 11 of the respirator 16, when worn, in his/her lower peripheral vision. The LED 20 signals the test instructions and results using a sequence of light flashes and colors, as mentioned above.

### Example 4

Referring now to FIG. 3 of the drawings, a similar arrangement to that shown in FIG. 2 is shown, except that in FIG. 3, it can be seen that the slide valve 48 is now in the closed position. This time, however, the fit-checking apparatus 10 takes the form of an adapter 56, which is sealingly interposed between one of the filter cartridges 44′ and the inlet aperture (not visible) of the oral nasal unit 52. This is accomplished, in certain embodiments, by the adaptor having a generally tubular configuration with an inlet and an outlet. The inlet has a female bayonet-type connector that sealingly connects, in use to the corresponding male bayonet connector of the filter cartridge 44′; and a male bayonet-type connector that sealingly connects to the female bayonet-type connector at the inlet of the respirator 16.

The indicator 20 takes the form of a stick 60, which extends upwardly so that its three LEDs 58 are visible to a user 11 in his/her peripheral vision when wearing the respirator 16. In this embodiment, the air pressure sensor (not visible) is located inside the tubular body of the adapter 56, which by its sealed connection to the filter cartridge 41′ and the oral nasal unit 52, forms part of the interior volume 14 of the respirator 16. In this embodiment, the indicator 20 has three LEDs, say a red, an amber and a green LED 58, which can be used, as described above and herein, to provide instructions and test results to the user 11.

### Example 5

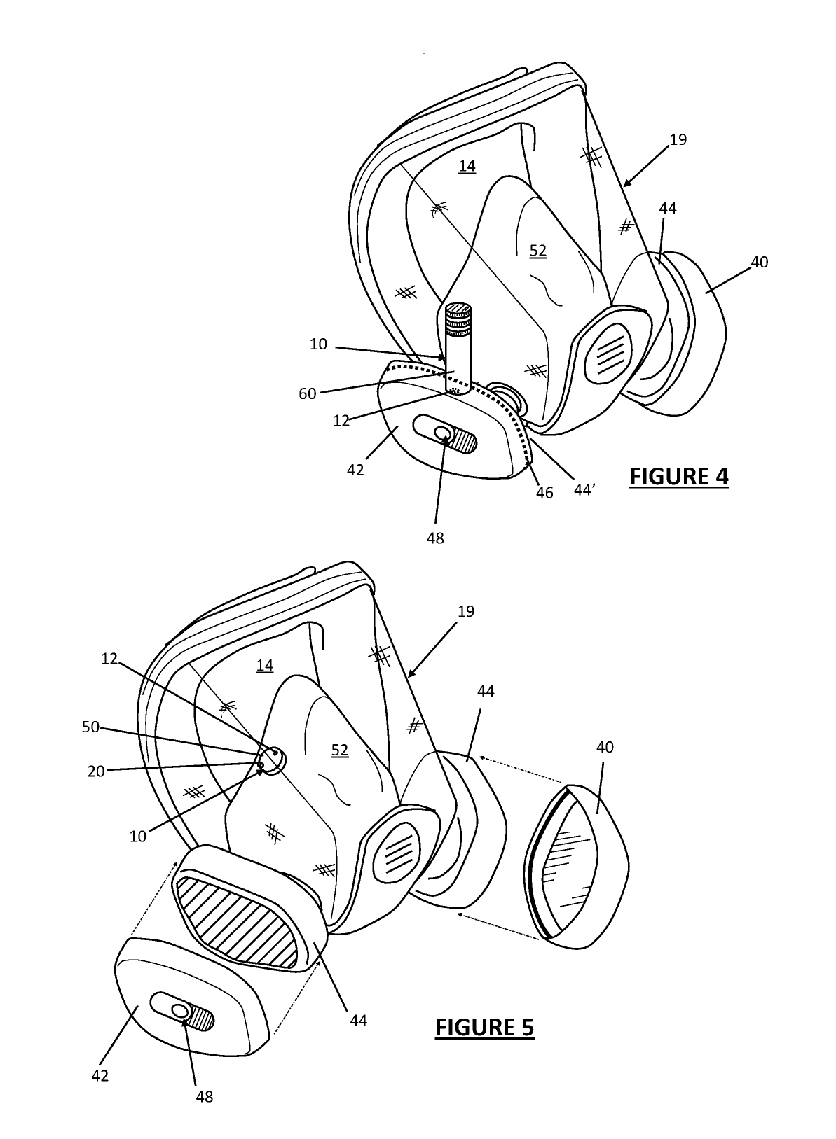

The embodiment shown in FIG. 4 of the drawings is slightly different again. This time, the fit-checking apparatus 10 is incorporated into one of the sealing caps 42 for one of the filter cartridges 44′ and is shown being used in conjunction with a full-face respirator 18. Clearly, this embodiment of the fit-checking apparatus 10 could be used in conjunction with, say the half-mask respirators 16 described above. Here, the pressure sensor 12 (shown in dotted lines) is mounted within the sealing cap 42, at the base of the stick part 60, and within the boundary defined by O-ring seal 46. Thus, the pressure sensor 12 is located within the interior volume 14 of the respirator 18. Again, the LEDs 20 are mounted so as to be visible to a user 11 of the respirator 18.

### Example 6

The embodiment of the invention shown in FIG. 5 of the drawings, fitted to a full-face respirator 18, sees the fit-checking apparatus 10 fitted to the exterior of the oral nasal unit 52. In this case, the pressure sensor 12 is located on the exterior of the main body 50 of the fit-checking apparatus 10, which is located within the interior volume 14 of the respirator 18; and the color-changing LED indicator 20 is mounted to as to be visible in the peripheral vision of the user 11.

### Example 7

Referring now to FIG. 6 of the drawings, this shows how the indicator 20 is visible in the peripheral vision of a user 11, when any of aforementioned embodiments of the fit-checking apparatus 10 are used. In the case of the embodiments shown in FIGS. 2 and 5, where the fit-checking apparatus 10 is permanently installed, it will be appreciated that the location of the fit-checking apparatus 10 will be carefully selected so as to not unduly restrict the user's field of view, but also so that the indicator 20 is visible in use. Other locations for the fit-checking apparatus 10, within the interior volume 14 of the respirator 16, 18, (such as, for example, affixed to the interior of the visor of the full-face respirator; or within the oral nasal unit 52 of a half-mask respirator 16) are within the scope of the invention.

### Example 8

In the embodiments shown in FIGS. 2 and 5 of the drawings, the indicator 20 comprises a single, color-changing LED. Initially, the LED 20 emits red light to indicate the start of a test procedure. The user puts on the respirator 16, 18, seals it to his/her face, closes-off the inlets (for example using the closure caps 40, 42 and by closing the valve 48) and inhales to reduce the pressure within the respirator 16, 18. The indicator LED 20 then flashes red as the pressure within 14 the respirator 16, 18 drops. Once the air pressure within the interior 14 of the respirator 16, 18 has fallen to, or below, the lower threshold value, the LED 20 changes to amber. The LED 20 then flashes amber to signal to the wearer 11 to hold his/her breath, followed by turning to continuous amber at the end of the test procedure. The test result can is then indicated by the LED 20 turning green to indicate a “pass” result, or red to indicate a “fail” result.

### Example 9

In the embodiments shown in FIGS. 3 and 6 of the drawings, the indicator 20 comprises three LEDs: a red, green and an amber LED. Initially, the red LED 20 is lit to indicate the start of a test procedure. The user puts on the respirator 16, 18, seals it to his/her face, closes-off the inlets (for example using the closure caps 40, 42 and by closing the valve 48) and inhales to reduce the pressure within the respirator 16, 18. The red LED 20 then flashes as the pressure within 14 the respirator 16, 18 drops. Once the air pressure within the interior 14 of the respirator 16, 18 has fallen to, or below, the lower threshold value, the amber LED illuminates. The amber LED 20 then to signal to the wearer 11 to hold his/her breath, followed by turning to continuous amber at the end of the test procedure. The test result is then indicated by the green LED 20 illuminating to indicate a “pass” result, or the red LED 20 illuminating to indicate a “fail” result.

### Example 10

Referring back to FIG. 1 now, an alternative embodiment of the invention sees the indicator 20 in the form of a smartphone application, which has a GUI 32. The GUI 32 has an “instructions” area 34, a “results” area 36 and a “user input” area 37. The user is prompted to wake-up the system by the “Wake” instruction 70 being highlighted on the GUI 32. The user presses a “wake” button 72, which is a touch-sensitive area of the user input area 37 of the GUI 32. A signal is then sent, via the wireless connection 26 to the fit-checking apparatus 10, and the CPU 22 begins polling the pressure sensor 12 for readings.

The “close seals” instruction 74 is then highlighted in the GUI, and the user 11 closes-off the respirator's inlets, as previously described. The user 11 confirms when this is done by pressing on a confirmation button 76 in the GUI 32.

Next, the “inhale” instruction 78 is highlighted in the GUI 32, and the user 11 begins to inhale. A progress indicator 80 of the GUI 32 indicates the pressure drop and prompts the user 11 to continue inhaling until the pressure within the interior 14 of the respirator 16, 18 has fallen to, or below, the lower threshold value. Once the lower threshold value has been reached, the progress indicator 80 changes colour, and the “hold” instruction 82 is highlighted in the GUI 32. The user holds his/her breath, and the progress indicator 80 then indicates the remaining test time to the user.

At the end of the test, the “open seals” instruction 84 is highlighted in the GUI 32, signalling to the user 11 to open the seals and to breathe again as normal.

The CPU 22 computes the test result and displays it in the results area 36 of the GUI 32. In the illustrated embodiment, a graph 86 of pressure versus time is plotted, along with a pass/fail result 88.

Again, the foregoing are just illustrative examples, and the scope of the invention is not limited by them.

### Example 11

FIG. 7 is a plot of fit factor 90 versus time 92 for an intact 94 and a damaged 96 respirator, as obtained using a known quantitate fit-checking system. In this example, the same respirator was used for both tests, but the “failed” respirator was simulated by placing a thin wire transverse to the peripheral seal, between the peripheral seal of the respirator and the wearer's face, so as to form a microscopic gap, thereby simulating a perforated or ill-fitting respirator. Here, the ambient concentration of contaminant in the air 98 is above 13,000 ppm in both cases. The fit factor 90 of the intact respirator 94 is above 10,000 for the entire duration of the test, and thus the intact respirator “passes”. On the other hand, the fit factor 90 of the (simulated) damaged respirator is 96 is below 10,000, thereby constituting a “fail”.

### Example 12

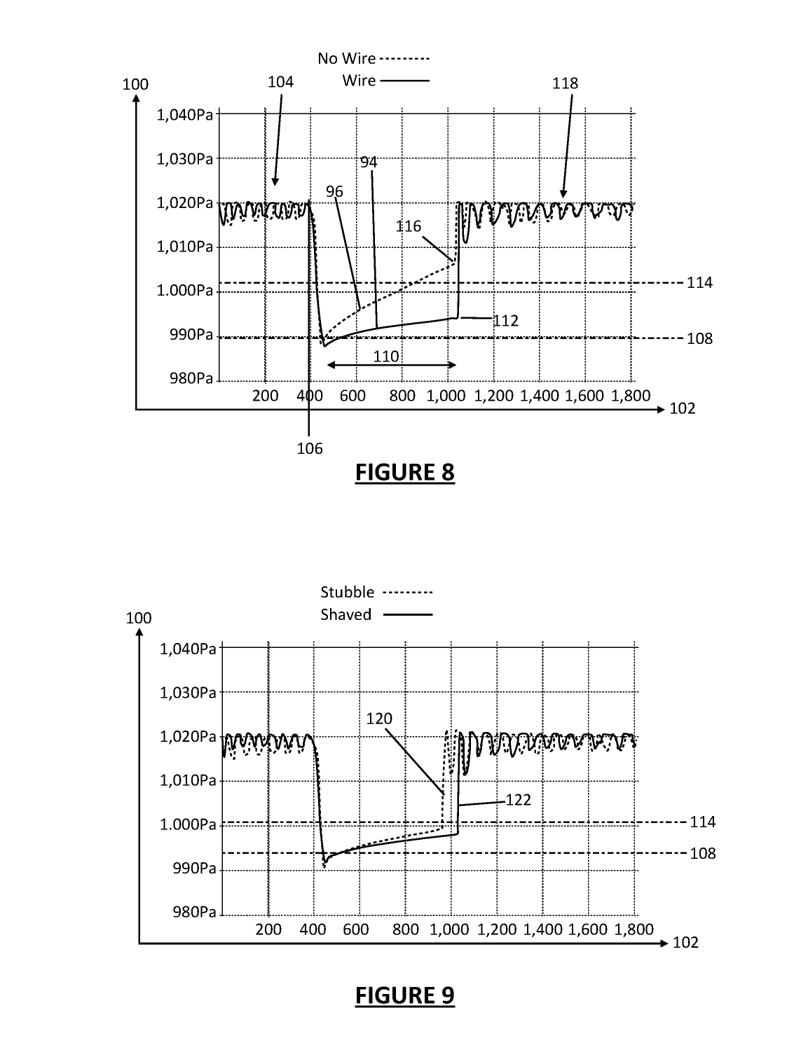

Turning now to FIG. 8 of the drawings, the same two respirators were tested using a fit-checking apparatus 10 in accordance with the invention. Here, air pressure 100 within the interior 14 of the respirator 16, 18 is plotted as a function of time 102.

Before the test 104, the pressure 100 within the interior 14 of the respirator 16, 18 rises and falls in-line with the user's normal breathing. At the start of the test 106, the respirator's inlets are closed-off and the user 11 inhales, to reduce the pressure 100 within the interior 14 of the respirator 16, 18 below a lower threshold value 108. The user 11 then holds his/her breath, for a period of time 110 and the pressure 100 within the interior 14 of the respirator 16, 18 is monitored, and plotted.

At the end of the test period 110, the pressure within the interior 14 of the respirator 16, 18 has risen slightly. In the case of the intact respirator 94, the pressure 112 within the interior 14 of the respirator 16, 18 is below the upper threshold value 114, indicating a “pass” result. Conversely, in the case of the damaged/ill-fitting respirator 96, the pressure 116 within the interior 14 of the respirator 16, 18 is above the upper threshold value 114, indicating a “fail” result.

At the end of the test 118, the user 11 opens the respirator's inlets again, and continues to breathe normally.

### Example 13

Finally, FIG. 9 is a comparison of the fit-check results, obtained for an intact respirator 16, 18, using a fit-checking apparatus in accordance with the invention, albeit on the same subject (user 11) with a beard/stubble 120, and clean-shaven 122. Even though the fit-check of the respirator is a pass in both cases (because the end-of-test air pressure 100 within the interior 14 of the respirator 16, 18 is below the upper threshold value 114, it can be seen that the fit-checking apparatus 10 in accordance with the invention is able to distinguish between the slightly better fit of the respirator when the user 11 is clean-shaven, as opposed to with stubble. It will also be appreciated that other test results could be obtained, for example, by measuring the slope and/or shape of the pressure-time graphs.

In all of the foregoing examples, the invention has been used in a “negative pressure test” configuration, that is to say measuring a decay in vacuum within the respirator during the interval of a fit-check procedure. It will be readily apparent, to the skilled reader, that the opposite is also true, and that substantially the same apparatus and test methodology could be used in reverse, that is to say with a positive pressure test procedure. For example, using any of the afore-described equipment, it would equally be possible to get the wearer to put on the respirator, form a seal, close-off any outlets of the respirator and start the fit-check procedure by exhaling, that is to say to “inflate” the sealed interior volume of the respirator. Then, the air pressure sensor can be used to monitor a drop in the internal air pressure of the respirator whilst the wearer is holding his/her breath, the decay in positive pressure being an indication of the integrity of the seal between the respirator and the wearer's face, or the presence or otherwise of any holes or leaks in the respirator itself. Where the equipment is used in a positive pressure test mode, it will be appreciated that the threshold values will need to be adapted to accord and/or reversed, where necessary. Nevertheless, it will be appreciated that the same principles apply mutatis mutandis to a positive pressure test scenario as they do to a negative pressure test scenario as described herein above.

The following statements are not the claims, but relate to various possible features and/or embodiments of the invention:

Statement 1. A respirator fit-check apparatus comprising: an air pressure sensor adapted, in use, to sense the air pressure within a sealed interior volume of a close-fitting respirator; an indicator adapted, in use, to indicate instructions and test results to a wearer of the respirator; and a CPU operatively connected to the air pressure sensor and to the indicator, wherein the CPU is adapted, in use, to: indicate, via the indicator, the start of a fit-check procedure and to monitor a drop in air pressure within the sealed interior volume of the respirator until a lower threshold air pressure value is reached; indicate, via the indicator, that the lower threshold air pressure value has been reached and to monitor the air pressure within the sealed interior volume of the respirator for a predetermined period of time; indicate, via the indicator, the expiry of the predetermined period of time; determine whether the measured air pressure within the sealed interior volume of the respirator at the end of the said predetermined period of time is below or above an upper threshold value; and if the measured air pressure within the sealed interior volume of the respirator at the end of the said predetermined period of time is below the upper threshold value, to indicate, via the indicator, a “pass” result; or if the measured air pressure within the sealed interior volume of the respirator at the end of the said predetermined period of time is above the upper threshold value, to indicate, via the indicator, a “fail” result.
Statement 2. The respirator fit-check apparatus of statement 1, wherein the air pressure sensor comprises an electronic pressure sensor.
Statement 3. The respirator fit-check apparatus of statement 1 or statement 2, wherein the air pressure sensor is located within an oral nasal unit of the respirator.
Statement 4. The respirator fit-check apparatus of statement 1 or statement 2, wherein the air pressure sensor is located, in use, between the visor and the wearer's face of a full-face respirator.
Statement 5. The respirator fit-check apparatus of statement 1 or statement 2, wherein the air pressure sensor is located within a filter cartridge or airline of the respirator.
Statement 6. The respirator fit-check apparatus of statement 1 or statement 2, wherein the air pressure sensor is located within an adaptor sealingly interposed between the respirator and one of its filter cartridges and/or airline.
Statement 7. The respirator fit-check apparatus of any preceding statement, wherein the indicator comprises an audible indicator.
Statement 8. The respirator fit-check apparatus of statement 7, wherein the indicator comprises a beeper or a speaker.
Statement 9. The respirator fit-check apparatus of statement 7 or statement 8, wherein, in use, the indicator is adapted to emit a first sound sequence to indicate the start of a test procedure, a second sound sequence whilst the wearer is inhaling, a third sound sequence to indicate that the pressure within the respirator has fallen to, or below, the lower threshold value, a fourth sound sequence to signal to the wearer to hold his/her breath, and a fifth sound sequence to signal the end of the test procedure.
Statement 10. The respirator fit-check apparatus of statements 7, 8 or 9, wherein the indicator is adapted, in use, to emit a sixth sound sequence to indicate a “pass” result; or a seventh sound sequence to indicate a “fail” result.
Statement 11. The respirator fit-check apparatus of any or statements 7 to 10, wherein any of the sound sequences comprises one or more sounds of different volumes, frequencies or durations.
Statement 12. The respirator fit-check apparatus of any preceding statement, wherein the indicator comprises a visual indicator.
Statement 13. The respirator fit-check apparatus of statement 12, wherein the indicator comprises a light or LED.
Statement 14. The respirator fit-check apparatus of statement 12 or statement 13, wherein, in use, the indicator is adapted to emit a first light sequence to indicate the start of a test procedure, a second light sequence whilst the wearer is inhaling, a third light sequence to indicate that the pressure within the respirator has fallen to, or below, the lower threshold value, a fourth light sequence to signal to the wearer to hold his/her breath, and a fifth light sequence to signal the end of the test procedure.
Statement 15. The respirator fit-check apparatus of statements 12, 13 or 14, therein the indicator is adapted, in use, to emit a sixth light sequence to indicate a “pass” result; or a seventh light sequence to indicate a “fail” result.
Statement 16. The respirator fit-check apparatus of any or statements 12 to 15, wherein any of the light sequences comprises one or more light emissions of different colours, intensities or durations.
Statement 17. The respirator fit-check apparatus of any preceding statement, wherein the indicator comprises a discrete unit wirelessly connected to the pressure sensor and/or CPU.
Statement 18. The respirator fit-check system of statement 17, wherein the discrete unit comprises app that is displayed, in use, on a computer, tablet PC or a smartphone device.
Statement 19. The respirator fit-check system of statement 18, wherein the app comprises an interactive GUI adapted to display instructions to the wearer and/or the test results.
Statement 20. The respirator fit-check system of any preceding statement, wherein the CPU has a substantially or completely powered-down mode and a powered-up mode, and wherein the CPU is switchable from the substantially or completely powered-down mode to the powered-up mode by a wake signal, the wake signal being generated by the air pressure sensor detecting a sudden pressure drop.
Statement 21. The respirator fit-check system of statement 19 or statement 20, wherein the CPU automatically switches from the powered-up mode to the substantially or completely powered-down mode after a predetermined interval.
Statement 22. The respirator fit-check system of any preceding statement, wherein the CPU comprises a processor, an I/O interface for the pressure sensor and indicator.
Statement 23. The respirator fit-check system of any preceding statement, wherein the CPU comprises a wireless transceiver.
Statement 24. The respirator fit-check system of any preceding statement, wherein the CPU comprises a memory.
Statement 25. A method of determining the fit of a close-fitting respirator, the method comprising: indicating, via an indicator, the start of a fit-check procedure; sealing the inlet of the respirator; a wearer of the respirator inhaling to reduce the pressure within a sealed interior volume of the respirator; monitoring, using an air pressure sensor located within the sealed interior volume of the respirator the reduction in air pressure within sealed interior volume of the respirator; upon the air pressure within sealed interior volume of the respirator reaching a lower threshold value, indicating to the wearer, using an indicator, to hold his/her breath; monitoring the air pressure within the sealed interior volume of the respirator for a predetermined period of time; indicating, via the indicator, the expiry of the predetermined period of time; and determining using a CPU operatively connected to the air pressure sensor and indicator, whether the measured air pressure within the sealed interior volume of the respirator at the end of the said predetermined period of time is below or above an upper threshold value; and if the measured air pressure within the sealed interior volume of the respirator at the end of the said predetermined period of time is below the upper threshold value, indicating, via the indicator, a “pass” result; or if the measured air pressure within the sealed interior volume of the respirator at the end of the said predetermined period of time is above the upper threshold value, indicating, via the indicator, a “fail” result.
Statement 26. The method of statement 25, wherein the air pressure is measured at intervals, and wherein the air pressure readings are recorded in a memory of the CPU.
Statement 27. The method of statement 26, comprising the step of plotting measured air pressure versus time, and analysing the gradient and/or shape of the plot.
Statement 28. The method of statement 27, further comprising the step of extrapolating the plot and predicting or determining whether a pass result would have been obtained if the test had been extended.
Statement 29. The method of statement 26, 27 or statement 287, further comprising the step of comparing the readings or plots obtained during different fit-checks.
Statement 30. The method of statement 25, further comprising the step of using the air pressure sensor to monitor the breathing rate and/or depth of a respirator wearers after the fit-check determination.
Statement 31. The method of statement 30, comprising the step of generating an alert signal in the event of a detected increase in breathing rate.
Statement 32. The method of statement 30, comprising the step of generating an alert signal in the event of a detected increase in breathing depth.
Statement 33. The method of statement 31 or statement 32, wherein the alert signal comprises any one or more of the group comprising an audible signal, a visible signal and an RF signals.
Statement 34. A method or apparatus substantially as hereinbefore described, with reference to, and as illustrated in, the accompanying drawings.

The invention is not restricted to the details of the foregoing embodiments, which are merely exemplary of various embodiments of the invention. For example, any materials, sized, shapes or configurations, whether explicit or implied, are exemplary, and are not necessarily restrictive of the scope of the invention, which is defined by the appended claims.

1. A respirator fit-check apparatus comprising:
an air pressure sensor adapted, in use, to sense the air pressure within a sealed interior volume of a close-fitting respirator;
an indicator adapted, in use, to indicate instructions and test results to a wearer of the respirator; and
a CPU operatively connected to the air pressure sensor and to the indicator, wherein the CPU is adapted, in use, to: indicate, via the indicator, the start of a fit-check procedure and to monitor a drop in air pressure within the sealed interior volume of the respirator until a lower threshold air pressure value is reached; indicate, via the indicator, that the lower threshold air pressure value has been reached and to monitor the air pressure within the sealed interior volume of the respirator for a predetermined period of time; indicate, via the indicator, the expiry of the predetermined period of time; determine whether the measured air pressure within the sealed interior volume of the respirator at the end of the said predetermined period of time is below or above an upper threshold value; and if the measured air pressure within the sealed interior volume of the respirator at the end of the said predetermined period of time is below the upper threshold value, to indicate, via the indicator, a “pass” result; or if the measured air pressure within the sealed interior volume of the respirator at the end of the said predetermined period of time is above the upper threshold value, to indicate, via the indicator, a “fail” result.

2. A respirator fit-check apparatus, comprising:
an air pressure sensor adapted, in use, to sense the air pressure within a sealed interior volume of a close-fitting respirator;
an indicator adapted, in use, to indicate instructions and test results to a wearer of the respirator; and
a CPU operatively connected to the air pressure sensor and to the indicator, wherein the CPU is adapted, in use, to: indicate, via the indicator, the start of a fit-check procedure and to monitor an increase in air pressure within the sealed interior volume of the respirator until an upper threshold air pressure value is reached; indicate, via the indicator, that the upper threshold air pressure value has been reached and to monitor the air pressure within the sealed interior volume of the respirator for a predetermined period of time; indicate, via the indicator, the expiry of the predetermined period of time; determine whether the measured air pressure within the sealed interior volume of the respirator at the end of the said predetermined period of time is below or above a lower threshold value; and if the measured air pressure within the sealed interior volume of the respirator at the end of the said predetermined period of time is above the lower threshold value, to indicate, via the indicator, a “pass” result; or if the measured air pressure within the sealed interior volume of the respirator at the end of the said predetermined period of time is below the lower threshold value, to indicate, via the indicator, a “fail” result.

3. The respirator fit-check apparatus of claim 1, wherein the CPU is adapted, in use, after a fit-check determination, and using the air pressure sensor, to monitor any one or more of the breathing rate and breathing depth of a wearer of the respirator.

4. The respirator fit-check apparatus of claim 3, wherein the CPU generates an alert signal in the event of any one or more of: a detected increase in breathing rate; and a detected increase in breathing depth, the alert signal comprising any one or more of the group comprising: an audible signal; a visible signal; and an RF signal.

5. The respirator fit-check apparatus of claim 1, wherein the air pressure sensor comprises an electronic pressure sensor.

6. The respirator fit-check apparatus of claim 1, wherein the air pressure sensor is located within any one or more of the group comprising: an oral nasal unit of the respirator; between the visor and the wearer's face of a full-face respirator; within a filter cartridge or airline of the respirator; and within an adaptor sealingly interposed between the respirator and one of its filter cartridges and/or airline.

7. The respirator fit-check apparatus of claim 1, wherein the indicator comprises a beeper or a speaker and is adapted, in use, to emit any one or more of the group comprising: a first sound sequence to indicate the start of a test procedure; a second sound sequence whilst the wearer is inhaling; a third sound sequence to indicate that the pressure within the respirator has fallen to, or below, the lower threshold value; a fourth sound sequence to signal to the wearer to hold his/her breath; a fifth sound sequence to signal the end of the test procedure; and a sixth sound sequence to indicate a “pass” result; or a seventh sound sequence to indicate a “fail” result.

8. The respirator fit-check apparatus of claim 7, wherein any of the sound sequences comprises one or more sounds of different volumes, frequencies or durations.

9. The respirator fit-check apparatus of claim 1, wherein the indicator comprises a light or an LED adapted, in use, to emit any one or more of the group comprising: a first light sequence to indicate the start of a test procedure; a second light sequence whilst the wearer is inhaling; a third light sequence to indicate that the pressure within the respirator has fallen to, or below, the lower threshold value; a fourth light sequence to signal to the wearer to hold his/her breath; a fifth light sequence to signal the end of the test procedure; and a sixth light sequence to indicate a “pass” result; or a seventh light sequence to indicate a “fail” result.

10. The respirator fit-check apparatus of claim 9, wherein any of the light sequences comprises one or more light emissions of different colors, intensities or durations.

11. The respirator fit-check apparatus of claim 1, wherein the indicator comprises a discrete unit wirelessly connected to the pressure sensor and/or CPU, the discrete unit being an application that is displayed, in use, on a computer, tablet PC or a smartphone device, the application comprising an interactive graphical user interface adapted to display instructions to the wearer and/or the test results.

12. The respirator fit-check system of claim 1, wherein the CPU has a substantially or completely powered-down mode and a powered-up mode, and wherein the CPU is switchable from the substantially or completely powered-down mode to the powered-up mode by a wake signal, the wake signal being generated by the air pressure sensor detecting a sudden pressure drop.

13. A method of determining the fit of a close-fitting respirator, the method comprising:
indicating, via an indicator, the start of a fit-check procedure;
sealing the inlet of the respirator, a wearer of the respirator inhaling to reduce the pressure within a sealed interior volume of the respirator;
monitoring, using an air pressure sensor located within the sealed interior volume of the respirator the reduction in air pressure within sealed interior volume of the respirator;
upon the air pressure within sealed interior volume of the respirator reaching a lower threshold value, indicating to the wearer, using an indicator, to hold his/her breath;
monitoring the air pressure within the sealed interior volume of the respirator for a predetermined period of time;
indicating, via the indicator, the expiry of the predetermined period of time; and
determining using a CPU operatively connected to the air pressure sensor and indicator, whether the measured air pressure within the sealed interior volume of the respirator at the end of the said predetermined period of time is below or above an upper threshold value; and
if the measured air pressure within the sealed interior volume of the respirator at the end of the said predetermined period of time is below the upper threshold value, indicating, via the indicator, a “pass” result; or if the measured air pressure within the sealed interior volume of the respirator at the end of the said predetermined period of time is above the upper threshold value, indicating, via the indicator, a “fail” result.

14. (canceled)

15. The method of claim 13, further comprising the step of using the air pressure sensor to monitor the breathing rate and/or depth of a respirator wearers after the fit-check determination and to generate an alert signal in the event of any one or more of the group comprising: a detected increase in breathing rate; and a detected increase in breathing depth.

16. The method of claim 15, wherein the alert signal comprises any one or more of the group comprising an audible signal, a visible signal and an RF signals.

17. The method of claim 13, wherein the air pressure is measured at intervals, and wherein the air pressure readings are recorded in a memory of the CPU, the method further comprising the step of plotting measured air pressure versus time, and analyzing the gradient and/or shape of the plot.

18. The method of claim 17, further comprising the step of extrapolating the plot and predicting or determining whether a pass result would have been obtained if the test had been extended.

19. The method of claim 17, further comprising the step of comparing the readings or plots obtained during different fit-checks.

20. The method of claim 18, further comprising the step of comparing the reading or plots obtained during different fit-checks.
